(19) United States
(12) Patent Application Publication
(10) Pub. No.: US 2003/0082390 A1
(43) Pub. Date: May 1, 2003

(54) Durable high barrier metallized polypropylene film

(76) Inventor: Keunsuk P. Chang, North Kingstown, RI (US)

Correspondence Address: Raj S. Dave, Ph.D., J.D., Morrison & Foerster LLP, Suite 300, 1650 Tysons Boulevard, McLean, VA, 22102, US

(21) Appl. No.: 10/270,734

(22) Filed: Oct. 16, 2002

Related U.S. Application Data
(60) Provisional application No. 60/330,088, filed on Oct. 19, 2001.

(51) Int. Cl. B32B 15/04

(52) U.S. Cl. 428/457; 428/461; 428/462

(57) ABSTRACT

A laminate film capable of providing an oxygen and water vapor barrier to a perishable product is disclosed. The laminate film comprises a polyolefin resin layer comprising a discharge-treated surface, a metal layer having an optical density of at least 2.0 deposited directly on said discharge-treated surface of said polyolefin resin layer and a crosslinked acrylate coating of at least 0.1 micron thickness deposited on said metal layer.

### RELATED APPLICATIONS

This application claims priority from Provisional Application Serial No. 60/330,088, filed Oct. 19, 2001, entitled the same as above, the entire disclosure of which is hereby incorporated herein by reference.

### FIELD OF INVENTION

This invention relates to a metallized polypropylene film containing a polyolefin layer and a metal deposited layer, over-coated in the metallizing chamber with a crosslinkable material and a method for producing same.

### BACKGROUND OF INVENTION

Biaxially oriented polypropylene metallized films are used for many packaging applications, particularly in food packaging, because they have important sealing and protective qualities. The films minimize the amount of light, moisture, and oxygen which can normally enter an ordinary, unprotected package. The films are often used in food packaging in combination with gas-flushing applications to protect the contents from moisture and oxidation. Also, the films often provide a heat sealable inner layer for bag forming and sealing.

Metallized films used in vertical-form-fill-seal (VFFS) packaging provide an excellent barrier in both unlaminated or laminated forms. However, because of the wide variety of forming collars used, bag sizes, filling speeds, and machine tensions used during the process of bag-forming, the laminated packaging containing the metallized film can be stretched in the packaging machine from 5 to 10% beyond the dimensions of the original film packaging. This stretching may cause fracture or cracks to form in the metal layer of the film. As a result, the packaging loses its protective properties. For instance, oxygen can readily pass through a damaged packaging film and cause unwanted oxidation of the contents.

High barrier metallized OPP films are typically metallized to an optical density range of 2.0-2.4. This has been shown to be adequate to provide good flat sheet (unelongated) barrier properties. However, such an optical density level alone has not been shown to provide good barrier durability during the bag forming process.

U.S. Pat. No. 5,698,317, the disclosure of which is incorporated herein by reference, discloses the use of a four layer packaging film having a polyolefin resin layer sandwiched between a polyolefin mixed resin layer comprising a petroleum or terpene resin and a heat sealable layer or non-sealable winding layer. A metal layer is then deposited on the surface of the polyolefin mixed resin layer. The metal layer is deposited following the discharge treatment of the polyolefin mixed resin layer. The inventors cite improvement in flat sheet barrier and metal adhesion to the substrate, but do not disclose any improvement in formed bag or elongated durability barrier.

U.S. Pat. No. 5,223,307 discloses a method to produce a vapor-deposited metallized packaging foil where an anti-friction coating is deposited upon the metal surface to provide protection of the metal from any damage and thus, maintain the impermeability of the foil to gases. U.S. Pat. No. 5,223,307 does not disclose a packaging foil having a crosslinked acrylate layer.

U.S. Pat. No. 4,842,893 discloses a process and materials for depositing acrylate coatings upon a substrate inside a vacuum chamber which is then cured via electron beam to form a protective coating. U.S. Pat. Nos. 5,725,909 and 6,231,939 (the Shaw patents) disclose a method to produce a gas barrier material. The Shaw patents disclose a flexible substrate having a first acrylate layer, a metal layer on the first acrylate and a second acrylate layer deposited upon the metal layer and cured. These patents, however, disclose the need to place the first acrylate layer directly on the thermoplastic sheet and then deposit a metal layer on the first acrylate layer.

The present invention improves upon the moisture and gas barrier properties as well as the durability of the metal layer.

### SUMMARY OF THE INVENTION

This invention provides a method to improve the flat sheet barrier and barrier durability of conventional metallized films resulting in a metallized high barrier packaging film with good formed bag barrier properties. The invention helps solve the problem of leaky bags associated with conventional metallized film packaging and the bag-forming process by providing a metal layer with an optical density of at least 2.0 and an acrylate coating deposited on top of the metal layer of at least 0.1 um which is then cured or crosslinked by electron beam. The metal layer is deposited on a polymer laminate film having at least two layers, a polyolefin resin layer and a heat sealable or a non-heat sealable, winding layer. The acrylate coating is then deposited upon the metal layer and is cured. The invention improves upon the moisture and gas barrier durability properties of laminate films.

The laminate film of the invention includes at least a 1, 2 or 3-layer coextruded film and a metal layer, preferably a vapor deposited aluminum layer, with at least an optical density of 1.8, preferably with an optical density of about 2.0 to 4.0, and even more preferably between 2.2 and 3.2. The aluminum layer is vapor deposited upon a discharge treated surface, preferably a discharge-treatment produced in a CO₂ and N₂ environment. Such discharge-treatment in a CO₂/N₂ atmosphere results in a treated surface containing at least 0.3% nitrogen-containing functional groups, and preferably at least 0.5% nitrogen-containing functional groups. In the case of the 2-layer laminate, the laminate film comprises a polymer resin, preferably a homopolymer polypropylene resin which has been discharge treated in the preferred method. In the case of a 3-layer laminate, the metal vapor is deposited upon a discharge treated surface (via the preferred method) containing a polyolefin mixed resin. This polyolefin mixed resin layer is disposed on one side of a homopolymer propylene core layer. A heat sealable surface or a winding surface containing antiblock and/or slip additives for good machinability and low coefficient of friction (COF) is disposed on the opposite side of the propylene core layer. Additionally, if the third layer is used as a winding surface, its surface may also be modified with a discharge treatment to make it suitable for laminating or converter applied adhesives and inks. The acrylate monomer is vaporized and deposited on the metallized flexible substrate and is cured by electron beam or ultra-violet radiation to form a coating that is 0.1-2.0 micron thick, preferably 0.2-1.0 micron in thickness, and more preferably between 0.2-0.5 micron in thickness.

As will be realized, this invention is capable of other and different embodiments, and its details are capable of modifications in various obvious respects, all without departing from this invention. Accordingly, the description is to be regarded as illustrative in nature and not as restrictive.

### BRIEF DESCRIPTION OF THE DRAWINGS

FIGS. 1a and 1b illustrate O2TR durability data of Ex. 1, Ex. 2, CEx. 1, and CEx. 2 graphically. FIG. 1b is the same data as FIG. 1a with the exception of Ex. 1 in order to illustrate the differences between Ex. 1, Ex. 2 and CEx. 2 more clearly.

FIG. 2 illustrates MVTR durability data of Ex. 1, Ex. 2, CEx. 1, and CEx. 2 graphically.

FIG. 3 illustrates O2TR durability of Ex. 1, Ex. 2, CEx. 3, and CEx. 4.

### DETAILED DESCRIPTION OF THE INVENTION

In one embodiment of the invention the laminate film comprises: a polyolefin resin layer, preferably a resin containing polypropylene; a heat sealable layer or a non-heat sealable, winding layer; a metal layer; and a cured coating of acrylate. The polyolefin resin layer will have a thickness of about 6 to 40 micron thick. The polyolefin resin layer is discharge treated, and the metal layer deposited on the treated resin layer. The discharge treatment is preferably conducted in an atmosphere of air, CO₂, N₂ or a mixture thereof, more preferably in a mixture of CO₂ and N₂. This method of discharge treatment results in a treated surface that comprises nitrogen-bearing functional groups, preferably 0.3% or more nitrogen in atomic %, and more preferably 0.5% or more nitrogen in atomic %.

The metal layer is preferably a vapor deposited metal, more preferably vapor deposited aluminum. The metal layer shall have a thickness between 5 and 100 nm, preferably between 30 and 70 nm; and an optical density between 2.0 and 4.0, preferably between 2.2 and 3.2.

The acrylate monomer is preferably a diacrylate or triacrylate monomer, of molecular weight between 100-1000, preferably between 200-500. The acrylate monomer is preferably vaporized and deposited on top of the vapor-deposited metal after said metal has been formed on the substrate. The acrylate monomer coating is then cured in situ, preferably using electron beam or ultra-violet radiation sufficient to polymerize the monomer into a solid and stable coating. This coating thickness is between 0.1-2.0 micron, preferably between 0.2-0.5 micron thick. It has been found that a coating of the above thickness significantly improves the flat sheet barrier (prior to bag-forming) as well as substantially improving the barrier durability (barrier after bag-forming). Without being bound to any theory, it is proposed that the cured acrylate coating forms a continuous surface upon the metal layer which: 1) Helps protect the metal surface from incidental damage and metal pick-off, thus improving the flat sheet barrier; and 2) Helps prevent the metal layer from fracturing under the stresses of bag-forming or elongation which the metal layer and substrate are subjected to during the course of bag-forming. It has also been found that when the coating thickness is less than 0.1 micron thick, the coating can become discontinuous, thus losing the benefits of barrier durability; when the coating is greater than 1.0 micron, no barrier durability properties are lost, however, no further improvement is found either, which thus wastes acrylate monomer material. This, in turn, raises the cost of such a product.

The heat scalable layer may contain an anti-blocking agent and/or slip additives for good machinability and a low coefficient of friction in about 0.05-0.5% by weight of the heat-sealable layer. The heat sealable layer will preferably comprise a ternary ethylene-propylene-butene copolymer. If the invention comprises a non-heat sealable, winding layer, this layer will comprise a crystalline polypropylene or a matte layer of a block copolymer blend of polypropylene and one or more other polymers whose surface is roughened during the film formation step so as to produce a matte finish on the winding layer. Preferably, the surface of the winding layer is discharge-treated to provide a functional surface for lamination or coating with adhesives and/or inks.

The polyolefin resin is coextruded with the heat sealable layer will have a thickness between 0.2 and 5 micron, preferably between 0.6 and 3 micron, and more preferably between 0.8 and 1.5 micron. The coextrusion process includes a two-layered compositing die. The two layer laminate sheet is cast onto a cooling drum whose surface temperature is controlled between 20° C. and 60° C. to solidify the non-oriented laminate sheet.

The non-oriented laminate sheet is stretched in the longitudinal direction at about 135 to 165° C. at a stretching ratio of about 4 to about 5 times the original length and the resulting stretched sheet is cooled to about 15° C. to 50° C. to obtain a uniaxially oriented laminate sheet. The uniaxially oriented laminate sheet is introduced into a tenter and preliminarily heated between 130° C. and 180° C., and stretched in the transverse direction at a stretching ratio of about 7 to about 12 times the original length and then heat set to give a biaxially oriented sheet. The biaxially oriented film has a total thickness between 6 and 40 micron, preferably between 10 and 20 micron, and most preferably between 12 and 18 micron.

The surface of the polyolefin resin layer of the biaxially oriented laminate film is subjected to a discharge treatment, preferably a corona-discharge treatment. The discharge treatment is preferably conducted in an atmosphere of air, CO₂, N₂ or a mixture thereof, and more preferably in a mixture of CO₂ and N₂. The treated laminate sheet is then wounded in a roll. The roll is placed in a metallizing chamber and the metal was vapor-deposited on the discharge treated polyolefin resin layer surface. The metal film may include titanium, vanadium, chromium, maganese, iron, cobalt, nickel, copper, zinc, aluminum, gold, or palladium, the preferred being aluminum. After formation of the metal layer, an acrylate monomer is vaporized and deposited upon said metal layer and cured in situ. The acrylate monomer may be a di- or tri-acrylate functionality, preferably of molecular weight between 200-500. The cured acrylate-coated metallized film is then tested for oxygen and moisture permeability and durability.

This invention will be better understood with reference to the following examples, which are intended to illustrate specific embodiments within the overall scope of the invention.

### EXAMPLE 1

One hundred parts by weight of a crystalline propylene homopolymer resin; 0.0001 parts by weight of a sodium calcium aluminosilicate powder or an amorphous silica having a mean particle diameter of 3 micron, were blended together. This mixture was coextruded with a heat sealable ternary ethylene-propylene-butene copolymer containing 4000 ppm of a crosslinked silicone polymer of mean particle diameter of 2 micron by weight of the heat sealable layer, and biaxially oriented to produce a 2-layer film where the propylene homopolymer resin layer was 16 micron thick and the accompanying coextruded ternary ethylene-propylene-butene copolymer layer was 1.5 micron thick. The total oriented film thickness was 17.5 micron or 70 G or 0.7 mil thick. The film was then discharge-treated in a controlled atmosphere of N₂ and CO₂, on the propylene homopolymer side (the metallizing surface) and wound in roll form. The roll was then metallized by vapor-deposition of aluminum onto the discharge-treated surface to an optical density target of 2.2-2.6. The roll was then coated by vapor-deposition of acrylate monomer and cured by electron beam of thickness 0.33 micron. The acrylate-coated metallized laminate film was then tested for oxygen and moisture permeability, optical density, and barrier durability.

### EXAMPLE 2

A process similar to Example 1 was repeated except that the cured acrylate coating thickness was 1.1 micron thick.

### Comparative Example 1

A process similar to Example 1 was repeated except that no acrylate monomer was deposited and cured on the vapor-deposited aluminum layer.

### Comparative Example 2

A process similar to Example 1 was repeated except that the cured acrylate coating thickness was 0.1 micron thick.

### Comparative Example 3

A process similar to Example 1 was repeated except that the coating was left uncured.

### Comparative Example 4

A process similar to Example 1 was repeated except that the optical density was 1.5.

### Test Methods

The various properties in the above examples were measured by the following methods:

Oxygen transmission rate of the film was measured by using a Mocon Oxtran 2/20 unit substantially in accordance with ASTM D3985. Moisture transmission rate of was measured by using a Mocon Permatran 3/31 unit measured substantially in accordance with ASTM F1249. Barrier durability of the film was measured by elongating test specimens in an Instron Tensile tester at 0, 3, 6, and 9% elongation. The elongated sample was then measured for barrier properties using Mocon Oxtran 2/20 or permatran 3/31 units. In general, preferred values of O₂TR would be equal or less than 46.5 cc/m²/day up to 9% elongation and MVTR would be equal or less than 0.69 g/m²/day up to 9% elongation.

Optical density was measured using a Tobias Associates model TBX transmission densitometer. Optical density is defined as the amount of light reflected from the test specimen under specific conditions. Optical density is reported in terms of a logarithmic conversion. For example, a density of 0.00 indicates that 100% of the light falling on the sample is being reflected. A density of 1.00 indicates that 10% of the light reflected; 2.00 is equivalent to 1%, etc.

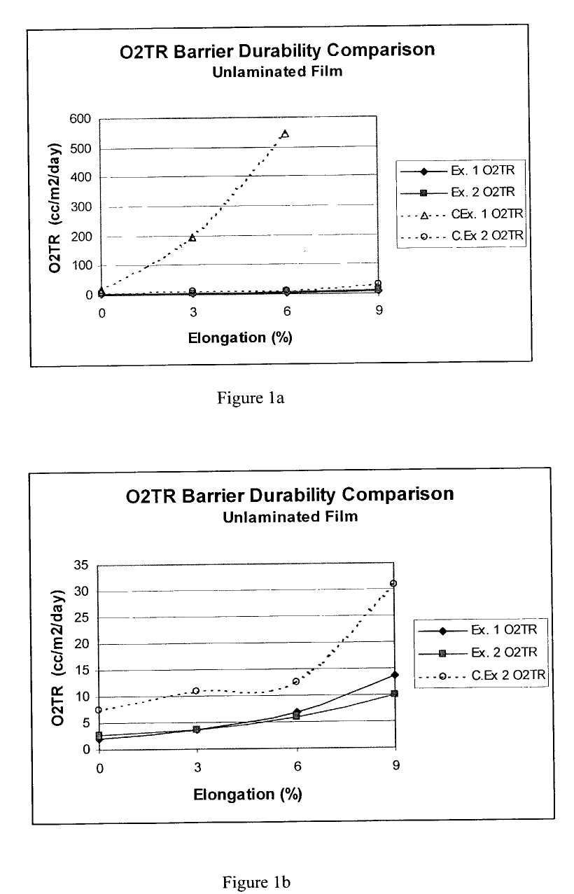

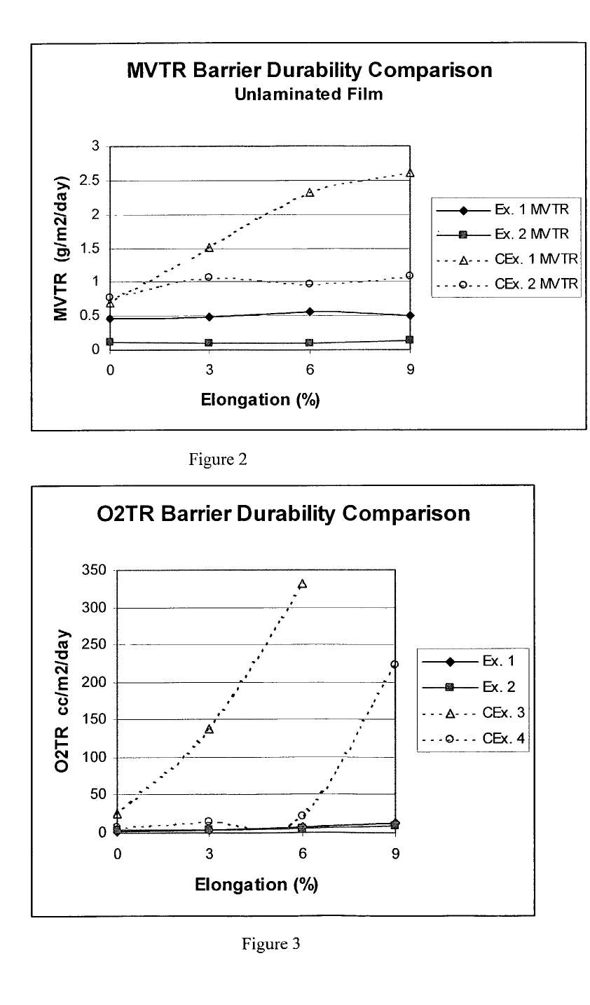

The results of the foregoing examples (“Ex.”) and comparative example (“CEx.”) are shown in Table 1, and FIGS. 1a, 1b, 2, and 3.

Table 1 shows the oxygen transmission rate (O2TR) of the metallized film samples at various elongations. The O2TR of the acrylate-coated metallized OPP samples (Ex. 1 and Ex. 2) show significantly improved O2TR barrier than the uncoated metallized OPP sample (CEx. 1), especially after elongation. Such significant improvement is due to the cured acrylate coating protecting the metal layer and thus can be of significant value to formed bag gas barrier in snack food packaging. Table 1 also shows that if the acrylate coating is too thin (CEx. 2), the effectiveness of the maintenance of barrier properties can be degraded, but is still better than an uncoated sample (CEx. 1). In addition, if the coating is not crosslinked, barrier durability is not improved (CEx. 3). If the optical density is too low (CEx. 4), although there may be some improvement in initial barrier properties, there is no significant improvement in barrier durability even with the crosslinked coating.

TABLE 1
O2TR Barrier Durability Comparison for Unlaminated Film

| Elongation | | | | | | |
|---|---|---|---|---|---|---|
| (%) | Ex. 1 | Ex. 2 | CEx. 1 | CEx. 2 | CEx. 3 | CEx. 4 |
| 0 | 2.1 | 2.8 | 20.8 | 7.6 | 25.4 | 7.8 |
| 3 | 3.7 | 3.7 | 195 | 10.8 | 138 | 14.8 |
| 6 | 6.8 | 5.9 | 547 | 12.4 | 332 | 22.2 |
| 9 | 13.6 | 9.9 | — | 31 | — | 223 |
| Optical | 2.24 | 2.31 | 2.32 | 2.26 | 2.21 | 1.5 |
| Density | | | | | | |

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. Persons skilled in the art would recognize that the numerical ranges disclosed inherently support any range within the disclosed numerical ranges even though a precise range limitation is not stated verbatim in the specification because this invention can be practiced throughout the disclosed numerical ranges. A holding to the contrary would “let form triumph over substance” and allow the written description requirement to eviscerate claims that might be narrowed during prosecution simply because the applicants broadly disclose in this application but then might narrow their claims during prosecution. Finally, the entire disclosure of the priority documents, patents and publications referred in this application are hereby incorporated herein by reference.

1. A laminate film, comprising:
a polyolefin resin layer comprising a discharge-treated surface;
a metal layer having a high optical density of at least 2.0 deposited directly on said discharge-treated surface of said polyolefin resin layer; and
a crosslinked acrylate coating of at least 0.1 micron thickness deposited on said metal layer.

2. The laminate film of claim 1, wherein a surface of the polyolefin resin layer opposite said discharge-treated surface comprises a heat sealable layer or winding layer comprising an antiblock selected from the group consisting of a non-polymeric antiblock and a polymeric antiblock.

3. The laminate film of claim 1, wherein said polyolefin resin layer has a thickness of about 6 to 40 micron.

4. The laminate film of claim 1, wherein said polyolefin resin layer comprises a polypropylene resin.

5. The laminate film of claim 2, wherein said heat-sealable layer or winding layer has a thickness of about 0.5 to 5.0 micron.

6. The laminate film of claim 2, wherein said heat sealable or winding layer comprises an anti-blocking agent of about 0.05 to 0.5 percent by weight of said heat sealable or winding layer.

7. The laminate film of claim 2, wherein said heat sealable layer comprises a ternary ethylene-propylene-butene copolymer.

8. The laminate film of claim 2, wherein said winding layer comprises a crystalline polypropylene or a matte layer of a block copolymer blend of polypropylene and one or more other polymers having a roughened surface.

9. The laminate film of claim 2, wherein said winding layer is treated to provide a surface for lamination or coating with adhesives or inks.

10. The laminate film of claim 1 or 2, wherein said metal layer has a thickness of about 5 to 100 nm.

11. The laminate film of claim 1 or 2, wherein said metal layer has an optical density of 2.0 to 5.0.

12. The laminate film of claim 1 or 2, wherein said metal layer comprises aluminum.

13. The laminate film of claim 1 or 2, wherein said discharge treatment of said polyolefin resin layer or second polyolefin resin layer is performed in an atmosphere of CO₂ and N₂.

14. The laminate film of claim 2, wherein the non-polymeric antiblock is selected from the group consisting of an amorphous silica, an aluminosilicate and a sodium calcium aluminum silicate

15. The laminate film of claim 2, wherein the non-polymeric antiblock is selected from the group consisting of crosslinked silicone polymer and polymethylmethacrylate.

16. The laminate film of claim 1, wherein the crosslinked acrylate coating is between 0.1 to 2 micron thick.

17. A laminate film, comprising:
a polyolefin resin layer comprising a discharge-treated surface;
a metal layer having an optical density of at least 2.0 deposited directly on said discharge-treated surface of said polyolefin resin layer; and
a crosslinked acrylate coating of at least 0.1 micron thickness deposited upon said metal layer and cured;
wherein the laminate film has a barrier durability at 9% elongation of less than or equal to 46.5 cc/m²/day O₂TR and less than or equal to 0.69 g/m²/day MVTR.

18. A method of providing an oxygen and water vapor barrier to a perishable product that is capable of degrading on exposure to oxygen and/or water vapor, comprising:
covering the perishable product with a laminate film and
exposing the laminate film to oxygen and/or water vapor,
wherein the laminate film comprises:
a polyolefin resin layer comprising a discharge-treated surface;
a metal layer having an optical density of at least 2.0 deposited directly on said discharge-treated surface of said polyolefin resin layer; and
a crosslinked acrylate coating of at least 0.1 micron thickness deposited upon said metal layer and cured;
wherein the laminate film has a barrier durability at 9% elongation of less than or equal to 46.5 cc/m²/day O₂TR and less than or equal to 0.69 g/m²/day MVTR.
